(19) United States
(12) Patent Application Publication
(10) Pub. No.: US 2025/0031125 A1
(43) Pub. Date: Jan. 23, 2025

(54) METHOD AND APPARATUS FOR SUPPORTING MULTI-HOP UE FOR UE-TO-UE RELAY IN A WIRELESS COMMUNICATION SYSTEM

(71) Applicant: ASUS Technology Licensing Inc., Taipei City 112028 (TW)

(72) Inventor: Richard Lee-Chee Kuo, Taipei City (TW)

(21) Appl. No.: 18/769,979

(22) Filed: Jul. 11, 2024

Related U.S. Application Data
(60) Provisional application No. 63/528,307, filed on Jul. 21, 2023.

(51) Int. Cl. H04W 40/02; H04W 76/20; H04W 88/04; H04W 92/18

(52) U.S. Cl. CPC H04W 40/02; H04W 76/20; H04W 88/04; H04W 92/18

(57) ABSTRACT

A method and device for supporting multi-hop UE-to-UE relay are disclosed. In one embodiment, the second relay UE is provided with a maximum number of hops specific for a Relay Service Code (RSC) by a network. Furthermore, the second relay UE receives a first PC5-S message from a first relay UE, wherein the first PC5-S message includes a User Info Identity (ID) of a first end UE, the RSC, and an accumulated number of hops. In addition, the second relay UE transmits or broadcasts a second PC5-S message if the accumulated number of hops plus 1 is less than the maximum number of hops, wherein the second PC5-S message includes the User Info ID of the first end UE and the RSC.

### CROSS-REFERENCE TO RELATED APPLICATIONS

The present Application claims the benefit of U.S. Provisional Patent Application Ser. No. 63/528,307 filed on Jul. 21, 2023, the entire disclosure of which is incorporated herein in its entirety by reference.

### FIELD

This disclosure generally relates to wireless communication networks, and more particularly, to a method and apparatus for supporting multi-hop UE-to-UE relay in a wireless communication system.

### BACKGROUND

With the rapid rise in demand for communication of large amounts of data to and from mobile communication devices, traditional mobile voice communication networks are evolving into networks that communicate with Internet Protocol (IP) data packets. Such IP data packet communication can provide users of mobile communication devices with voice over IP, multimedia, multicast and on-demand communication services.

An exemplary network structure is an Evolved Universal Terrestrial Radio Access Network (E-UTRAN). The E-UTRAN system can provide high data throughput in order to realize the above-noted voice over IP and multimedia services. A new radio technology for the next generation (e.g., 5G) is currently being discussed by the 3GPP standards organization. Accordingly, changes to the current body of 3GPP standard are currently being submitted and considered to evolve and finalize the 3GPP standard.

### SUMMARY

A method and device for supporting multi-hop UE-to-UE relay are disclosed. In one embodiment, the second relay UE is provided with a maximum number of hops specific for a Relay Service Code (RSC) by a network. Furthermore, the second relay UE receives a first PC5-S message from a first relay UE, wherein the first PC5-S message includes a User Info Identity (ID) of a first end UE, the RSC, and a first accumulated number of hops. In addition, the second relay UE transmits or broadcasts a second PC5-S message if the first accumulated number of hops plus 1 is less than or equal to the maximum number of hops, wherein the second PC5-S message includes the User Info ID of the first end UE and the RSC.

### BRIEF DESCRIPTION OF THE DRAWINGS

FIG. 1 shows a diagram of a wireless communication system according to one exemplary embodiment.

FIG. 2 is a block diagram of a transmitter system (also known as access network) and a receiver system (also known as user equipment or UE) according to one exemplary embodiment.

FIG. 3 is a functional block diagram of a communication system according to one exemplary embodiment.

FIG. 4 is a functional block diagram of the program code of FIG. 3 according to one exemplary embodiment.

FIG. 5 is a reproduction of Figure 4.2.8-1 of 3GPP TS 23.304 V18.2.0.

FIG. 6 is a reproduction of Figure 6.3.2.1-1 of 3GPP TS 23.304 V18.2.0.

FIG. 7 is a reproduction of Figure 6.3.2.1-2 of 3GPP TS 23.304 V18.2.0.

FIG. 8 is a reproduction of Figure 6.3.2.4.2-1 of 3GPP TS 23.304 V18.2.0.

FIG. 9 is a reproduction of Figure 6.3.2.4.3-1 of 3GPP TS 23.304 V18.2.0.

FIG. 10 is a reproduction of Figure 6.4.3.1-1 of 3GPP TS 23.304 V18.2.0.

FIG. 11 is a reproduction of Figure 6.7.3.2-1 of 3GPP TS 23.304 V18.2.0.

FIG. 12 is a reproduction of Figure 6.7.3.3-1 of 3GPP TS 23.304 V18.2.0.

FIG. 13 is a reproduction of Figure 11.2.y.1 of 3GPP TS 24.554 V18.1.0.

FIG. 14 is a reproduction of Table 11.2.y.1 of 3GPP TS 24.554 V18.1.0.

FIG. 15 illustrates an exemplary 3-hop UE-to-UE Relay according to one exemplary embodiment.

FIG. 16 illustrates a multi-hop UE-to-UE Relay according one exemplary embodiment.

FIG. 17 illustrates a multi-route UE-to-UE Relay according to one exemplary embodiment.

FIG. 18 is a flow chart according to one exemplary embodiment.

FIG. 19 is a flow chart according to one exemplary embodiment.

### DETAILED DESCRIPTION

The exemplary wireless communication systems and devices described below employ a wireless communication system, supporting a broadcast service. Wireless communication systems are widely deployed to provide various types of communication such as voice, data, and so on. These systems may be based on code division multiple access (CDMA), time division multiple access (TDMA), orthogonal frequency division multiple access (OFDMA), 3GPP LTE (Long Term Evolution) wireless access, 3GPP LTE-A or LTE-Advanced (Long Term Evolution Advanced), 3GPP2 UMB (Ultra Mobile Broadband), WiMax, 3GPP NR (New Radio), or some other modulation techniques.

In particular, the exemplary wireless communication systems and devices described below may be designed to support one or more standards such as the standard offered by a consortium named “3rd Generation Partnership Project” referred to herein as 3GPP, including: TS 23.304 V18.2.0, “Proximity based Services (ProSe) in the 5G System (5GS) (Release 18)”; TS 24.554 V18.1.0, “Proximity-services (ProSe) in 5G System (5GS) protocol aspects; Stage 3 (Release 18)”; and TS 22.261 V19.3.0, “Service requirements for the 5G system; Stage 1 (Release 19)”. The standards and documents listed above are hereby expressly incorporated by reference in their entirety.

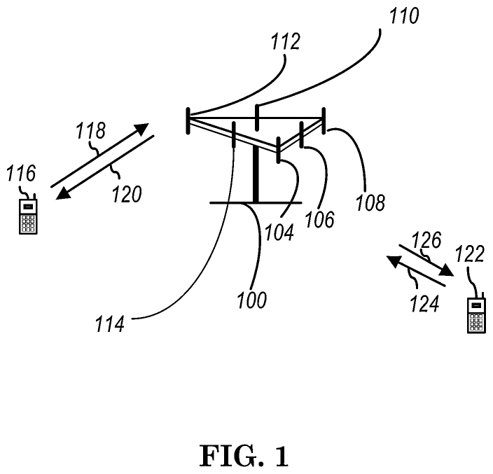

FIG. 1 shows a multiple access wireless communication system according to one embodiment of the invention. An access network 100 (AN) includes multiple antenna groups, one including 104 and 106, another including 108 and 110, and an additional including 112 and 114. In FIG. 1, only two antennas are shown for each antenna group, however, more or fewer antennas may be utilized for each antenna group. Access terminal 116 (AT) is in communication with antennas 112 and 114, where antennas 112 and 114 transmit information to access terminal 116 over forward link 120 and receive information from access terminal 116 over reverse link 118. Access terminal (AT) 122 is in communication with antennas 106 and 108, where antennas 106 and 108 transmit information to access terminal (AT) 122 over forward link 126 and receive information from access terminal (AT) 122 over reverse link 124. In a FDD system, communication links 118, 120, 124 and 126 may use different frequency for communication. For example, forward link 120 may use a different frequency then that used by reverse link 118.

Each group of antennas and/or the area in which they are designed to communicate is often referred to as a sector of the access network. In the embodiment, antenna groups each are designed to communicate to access terminals in a sector of the areas covered by access network 100.

In communication over forward links 120 and 126, the transmitting antennas of access network 100 may utilize beamforming in order to improve the signal-to-noise ratio of forward links for the different access terminals 116 and 122. Also, an access network using beamforming to transmit to access terminals scattered randomly through its coverage causes less interference to access terminals in neighboring cells than an access network transmitting through a single antenna to all its access terminals.

An access network (AN) may be a fixed station or base station used for communicating with the terminals and may also be referred to as an access point, a Node B, a base station, an enhanced base station, an evolved Node B (eNB), a network node, a network, or some other terminology. An access terminal (AT) may also be called user equipment (UE), a wireless communication device, terminal, access terminal or some other terminology.

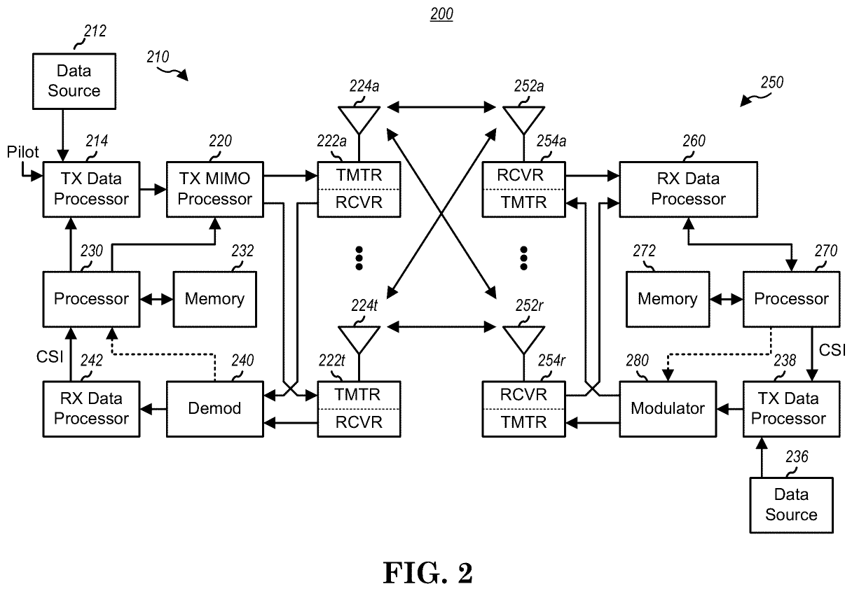

FIG. 2 is a simplified block diagram of an embodiment of a transmitter system 210 (also known as the access network) and a receiver system 250 (also known as access terminal (AT) or user equipment (UE)) in a MIMO system 200. At the transmitter system 210, traffic data for a number of data streams is provided from a data source 212 to a transmit (TX) data processor 214.

In one embodiment, each data stream is transmitted over a respective transmit antenna. TX data processor 214 formats, codes, and interleaves the traffic data for each data stream based on a particular coding scheme selected for that data stream to provide coded data.

The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (i.e., symbol mapped) based on a particular modulation scheme (e.g., BPSK, QPSK, M-PSK, or M-QAM) selected for that data stream to provide modulation symbols. The data rate, coding, and modulation for each data stream may be determined by instructions performed by processor 230.

The modulation symbols for all data streams are then provided to a TX MIMO processor 220, which may further process the modulation symbols (e.g., for OFDM). TX MIMO processor 220 then provides N_{T} modulation symbol streams to N_{T} transmitters (TMTR) 222a through 222t. In certain embodiments, TX MIMO processor 220 applies beamforming weights to the symbols of the data streams and to the antenna from which the symbol is being transmitted.

Each transmitter 222 receives and processes a respective symbol stream to provide one or more analog signals, and further conditions (e.g., amplifies, filters, and upconverts) the analog signals to provide a modulated signal suitable for transmission over the MIMO channel. N_{T} modulated signals from transmitters 222a through 222t are then transmitted from N_{T} antennas 224a through 224t, respectively.

At receiver system 250, the transmitted modulated signals are received by N_{R} antennas 252a through 252r and the received signal from each antenna 252 is provided to a respective receiver (RCVR) 254a through 254r. Each receiver 254 conditions (e.g., filters, amplifies, and downconverts) a respective received signal, digitizes the conditioned signal to provide samples, and further processes the samples to provide a corresponding “received” symbol stream.

An RX data processor 260 then receives and processes the N_{R} received symbol streams from N_{R} receivers 254 based on a particular receiver processing technique to provide N_{T} “detected” symbol streams. The RX data processor 260 then demodulates, deinterleaves, and decodes each detected symbol stream to recover the traffic data for the data stream. The processing by RX data processor 260 is complementary to that performed by TX MIMO processor 220 and TX data processor 214 at transmitter system 210.

A processor 270 periodically determines which pre-coding matrix to use (discussed below). Processor 270 formulates a reverse link message comprising a matrix index portion and a rank value portion.

The reverse link message may comprise various types of information regarding the communication link and/or the received data stream. The reverse link message is then processed by a TX data processor 238, which also receives traffic data for a number of data streams from a data source 236, modulated by a modulator 280, conditioned by transmitters 254a through 254r, and transmitted back to transmitter system 210.

At transmitter system 210, the modulated signals from receiver system 250 are received by antennas 224, conditioned by receivers 222, demodulated by a demodulator 240, and processed by a RX data processor 242 to extract the reserve link message transmitted by the receiver system 250. Processor 230 then determines which pre-coding matrix to use for determining the beamforming weights then processes the extracted message.

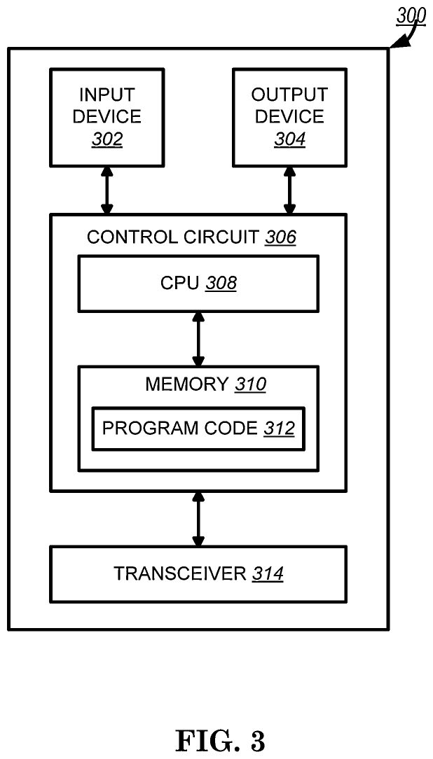

Turning to FIG. 3, this figure shows an alternative simplified functional block diagram of a communication device according to one embodiment of the invention. As shown in FIG. 3, the communication device 300 in a wireless communication system can be utilized for realizing the UEs (or ATs) 116 and 122 in FIG. 1 or the base station (or AN) 100 in FIG. 1, and the wireless communications system is preferably the N_{R} system. The communication device 300 may include an input device 302, an output device 304, a control circuit 306, a central processing unit (CPU) 308, a memory 310, a program code 312, and a transceiver 314. The control circuit 306 executes the program code 312 in the memory 310 through the CPU 308, thereby controlling an operation of the communications device 300. The communications device 300 can receive signals input by a user through the input device 302, such as a keyboard or keypad, and can output images and sounds through the output device 304, such as a monitor or speakers. The transceiver 314 is used to receive and transmit wireless signals, delivering received signals to the control circuit 306, and outputting signals generated by the control circuit 306 wirelessly. The communication device 300 in a wireless communication system can also be utilized for realizing the AN 100 in FIG. 1.

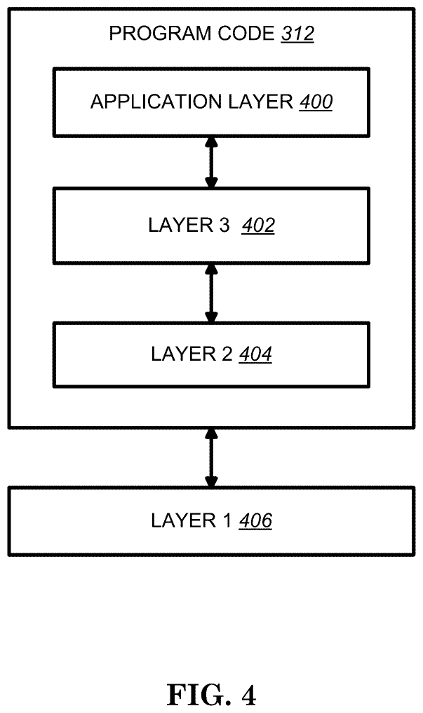

FIG. 4 is a simplified block diagram of the program code 312 shown in FIG. 3 in accordance with one embodiment of the invention. In this embodiment, the program code 312 includes an application layer 400, a Layer 3 portion 402, and a Layer 2 portion 404, and is coupled to a Layer 1 portion 406. The Layer 3 portion 402 generally performs radio resource control. The Layer 2 portion 404 generally performs link control. The Layer 1 portion 406 generally performs physical connections.

3GPP TS 23.304 specifies procedures related to UE-to-UE Relay as follows:

### 4.2.8 5G ProSe UE-to-UE Relay Reference Architecture

Figure 4.2.8-1 shows the Layer-2 and Layer-3 5G ProSe UE-to-UE Relay reference architecture. The 5G ProSe End UEs communicate with each other via a 5G ProSe UE-to-UE Relay.

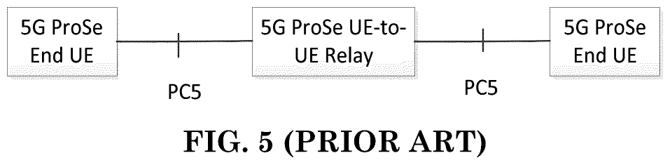

### [Figure 4.2.8-1 of 3GPP TS 23.304 V18.2.0, Entitled “Reference Architecture for 5G ProSe UE-to-UE Relay”, is Reproduced as FIG. 5]

Each 5G ProSe End UE and the 5G ProSe UE-to-UE Relay may have subscriptions from the same PLMN or different PLMNs.

[ . . . ]

### 5.1.5.1 Policy/Parameter Provisioning for 5G ProSe UE-to-UE Relay

The following information is provisioned in the UE in support of the UE assuming the role of a 5G ProSe UE-to-UE Relay:

1) Authorisation policy for acting as a 5G ProSe Layer-3 and/or Layer-2 UE-to-UE Relay when the UE is “served by NG-RAN”:
PLMNs in which the UE is authorized to relay traffic for 5G ProSe Layer-3 and/or Layer-2 End UEs accessing 5G ProSe UE-to-UE Relays over PC5 reference point.
The authorisation for a UE to act as a 5G ProSe UE-to-UE Relay also authorizes the use of 5G ProSe UE-to-UE Relay Discovery with Model A and Model B.

NOTE 1: It is up to UE and application implementation to select a discovery model, or whether to perform both models simultaneously.

2) ProSe Relay Discovery policy/parameters for 5G ProSe UE-to-UE Relay:
Includes the parameters that enable the UE to perform 5G ProSe UE-to-UE Relay Discovery when provided by PCF or provisioned in the ME or configured in the UICC:
   5G ProSe UE-to-UE Relay Discovery parameters (User Info ID, Relay Service Code(s), UE-to-UE Relay Layer indicator). The UE-to-UE Relay Layer indicator indicates whether the associated RSC is offering 5G ProSe Layer-2 or Layer-3 UE-to-UE Relay service.
   Default Destination Layer-2 ID(s) for sending Relay Discovery Announcement message and receiving Relay Discovery Solicitation messages;
   Default Destination Layer-2 ID(s) for sending/receiving Direct Communication Request message for ProSe UE-to-UE Relay Communication with integrated Discovery;
   For 5G ProSe Layer-3 UE-to-UE Relay, the traffic type (IP, Ethernet, Unstructured) to be used for the relayed traffic for each Relay Service Code;
   Includes security related content for Relay Discovery for each Relay Service Code.

NOTE 2: SA WG3 will determine the security related content for 5G ProSe UE-to-UE Relay.

3) Validity time indicating the expiration time of the Policy/Parameter for 5G ProSe UE-to-UE Relay discovery and communication.

The following information is provisioned in the UE in support of the UE assuming the role of a 5G ProSe End UE and thereby enabling the use of a 5G ProSe UE-to-UE Relay:

1) Authorisation policy for using a 5G ProSe Layer-3 and/or Layer-2 UE-to-UE Relay:
whether the UE is authorised to use a 5G ProSe Layer-3 and/or Layer-2 UE-to-UE Relay. The authorisation for a UE to act as a 5G ProSe End UE also authorizes the use of 5G ProSe UE-to-UE Relay discovery with Model A and Model B.

NOTE 3: It is up to UE and application implementation to select a discovery model, or whether to perform both models simultaneously.

2) Policy/parameters for 5G ProSe UE-to-UE Relay Discovery:
Includes the parameters for 5G ProSe UE-to-UE Relay Discovery as a 5G ProSe End UE and for enabling the UE to connect to the 5G ProSe UE-to-UE Relay after discovery when provided by PCF or provisioned in the ME or configured in the UICC:
   5G ProSe UE-to-UE Relay Discovery parameters (User Info ID, Relay Service Code(s), UE-to-UE Relay Layer indicator). The UE-to-UE Relay Layer indicator indicates whether the associated RSC is offering 5G ProSe Layer-2 or Layer-3 UE-to-UE Relay service.
   Default Destination Layer-2 ID(s) for sending Relay Discovery Solicitation messages and receiving Relay Discovery Announcement message;
   Default Destination Layer-2 ID(s) for sending/receiving Direct Communication Request message for ProSe UE-to-UE Relay Communication with integrated Discovery;
   For 5G ProSe Layer-3 UE-to-UE Relay, the traffic type (IP, Ethernet, Unstructured) to be used for the relayed traffic for each Relay Service Code;
   Includes security related content for Relay Discovery for each Relay Service Code.

NOTE 4: SA WG3 will determine the security related content for 5G ProSe UE-to-UE Relay.

3) Validity time indicating the expiration time of the Policy/Parameter for 5G ProSe UE-to-UE Relay discovery and communication.

The following information is provisioned in the UE in support of the UE assuming the role of a 5G ProSe UE-to-UE Relay as well as in the UE in support of the UE assuming the role of a 5G ProSe End UE and thereby enabling the use of a 5G ProSe UE-to-UE Relay:

1) Radio parameters for 5G ProSe UE-to-UE Relay Discovery when the UE is not “served by NG-RAN”:
Includes the radio parameters N_{R} PC5 with Geographical Area(s) and an indication of whether they are “operator managed” or “non-operator managed”. The UE uses the radio parameters to perform 5G ProSe Direct Discovery over PC5 reference point when “not served by NG-RAN” only if the UE can reliably locate itself in the corresponding Geographical Area. Otherwise, the UE is not authorized to transmit.
Default PC5 DRX configuration (see TS 38.331 [16]).

NOTE 5: RAN WG2 will determine the default PC5 DRX configuration for 5G ProSe UE-to-UE relay scenario.

NOTE 6: Radio parameters for 5G ProSe UE-to-UE Relay Discovery when the UE is not “served by NG-RAN” and Radio parameters when the UE is “not served by NG-RAN” for 5G ProSe Direct Discovery in clause 5.1.2.1 are expected to be aligned for direct and relayed discovery for UE to UE communication.

2) Radio parameters for 5G ProSe UE-to-UE Relay communication when the UE is not “served by NG-RAN”:
Includes the radio parameters NR PC5 with Geographical Area(s) and an indication of whether they are “operator managed” or “non-operator managed”. The UE uses the radio parameters to perform 5G ProSe Direct Communication over PC5 reference point when “not served by NG-RAN” only if the UE can reliably locate itself in the corresponding Geographical Area. Otherwise, the UE is not authorized to transmit.

NOTE 7: Radio parameters for 5G ProSe UE-to-UE Relay communication when the UE is not “served by NG-RAN” and Radio parameters when the UE is “not served by NG-RAN” for 5G ProSe Direct Communication in clause 5.1.3.1 are expected to be aligned for direct and relayed UE to UE communication.

[ . . . ]

### 6.3.2 5G ProSe Direct Discovery Procedures Over PC5 Reference Point

### 6.3.2.1 General

A PC5 communication channel is used to carry the discovery message over PC5 and the discovery message over PC5 is differentiated from other PC5 messages by AS layer. Both Model A and Model B discovery as defined in TS 23.303 [3] are supported:
Model A uses a single discovery protocol message (Announcement).
Model B uses two discovery protocol messages (Solicitation and Response).

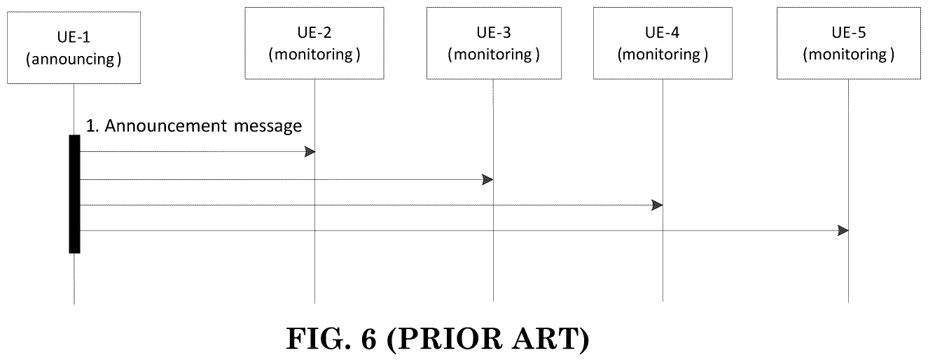

Depicted in Figure 6.3.2.1-1 is the procedure for 5G ProSe Direct Discovery with Model A.

[Figure 6.3.2.1-1 of 3GPP TS 23.304 V18.2.0, Entitled “5G ProSe Direct Discovery with Model A”, is Reproduced as FIG. 6]

1. The Announcing UE sends an Announcement message. The Announcement message may include the Type of Discovery Message, ProSe Application Code or ProSe Restricted Code, relay_Indication, security protection element, [metadata information]. The Application layer metadata information may be included as metadata in the Announcement message.

The Destination Layer-2 ID and Source Layer-2 ID used to send the Announcement message are specified in clause 5.8.1.2 and clause 5.8.1.3.

Announcing UE includes the relay_Indication if 5G ProSe UE-to-UE Relay(s) can broadcast its User Info ID during the 5G ProSe UE-to-UE Discovery.

The Monitoring UE determines the Destination Layer-2 ID for signalling reception. The Destination Layer-2 ID is configured with the UE(s) as specified in clause 5.8.1.2.

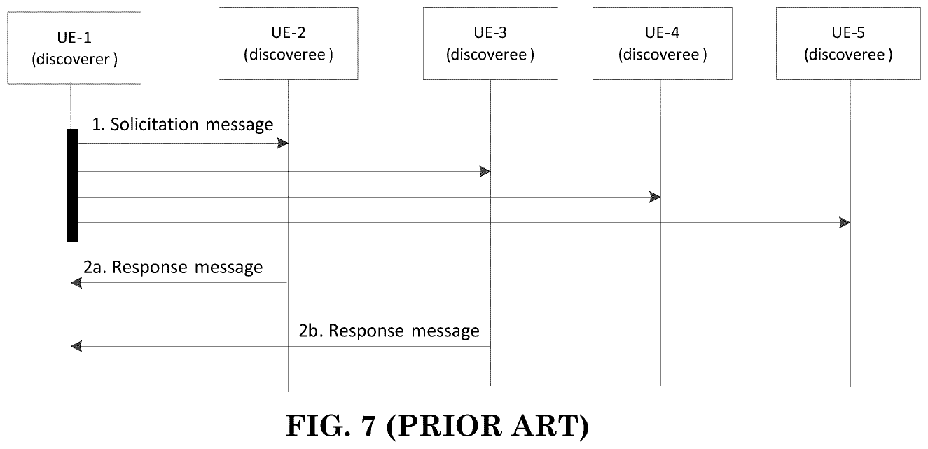

Depicted in Figure 6.3.2.1-2 is the procedure for 5G ProSe Direct Discovery with Model B.

[Figure 6.3.2.1-2 of 3GPP TS 23.304 V18.2.0, Entitled “5G ProSe Direct Discovery with Model B”, is Reproduced as FIG. 7]

1. The Discoverer UE sends a Solicitation message. The Solicitation message may include

Type of Discovery Message, ProSe Query Code, relay_Indication, security protection element.

The Destination Layer-2 ID and Source Layer-2 ID used to send the Solicitation message are specified in clause 5.8.1.2 and clause 5.8.1.3.

How the Discoveree UE determines the Destination Layer-2 ID for signalling reception is specified in clause 5.8.1.2.

Discoverer UE includes the relay_Indication if 5G ProSe UE-to-UE Relay(s) can broadcast its User Info ID during the 5G ProSe UE-to-UE Discovery.

2. The Discoveree UE that matches the solicitation message responds to the Discoverer UE with the Response message. The Response message may include Type of Discovery Message, ProSe Response Code, relay_Indication, security protection element, [metadata information]. The Application layer metadata information may be included as metadata in the Response message.

Discoveree UE includes relay_Indication if 5G ProSe UE-to-UE Relay(s) can broadcast its User Info ID during the 5G ProSe UE-to-UE Discovery.

The Source Layer-2 ID used to send the Response message is specified in clause 5.8.1.3.

The Destination Layer-2 ID is set to the Source Layer-2 ID of the received Solicitation message.

NOTE: Details of security protection element are specified in TS 33.503 [29].

[ . . . ]

### 6.3.2.4 5G ProSe UE-to-UE Relay Discovery

### 6.3.2.4.1 General

5G ProSe UE-to-UE Relay Discovery is applicable to both 5G ProSe Layer-3 and Layer-2 UE-to-UE Relay Discovery for public safety use and commercial services. To perform 5G ProSe UE-to-UE Relay Discovery, the 5G ProSe End UE and the 5G ProSe UE-to-UE Relay are pre-configured or provisioned with the related information as described in clause 5.1.

A Relay Service Code (RSC) is used in the 5G ProSe UE-to-UE Relay Discovery, to indicate the connectivity service the 5G ProSe UE-to-UE Relay provides to 5G ProSe End UEs. The RSCs are pre-configured or provisioned on the 5G ProSe UE-to-UE Relay and the 5G ProSe End UE as defined in clause 5.1. The 5G ProSe UE-to-UE Relay and the 5G ProSe End UE are aware of whether a RSC is offering 5G ProSe Layer-2 or Layer-3 UE-to-UE Relay service based the policy as specified in clause 5.1. A 5G ProSe UE-to-UE Relay supporting multiple RSCs advertises the RSCs using multiple discovery messages, with one RSC per discovery message.

6.3.2.4.2 Procedure for 5G ProSe UE-to-UE Relay Discovery with Model A

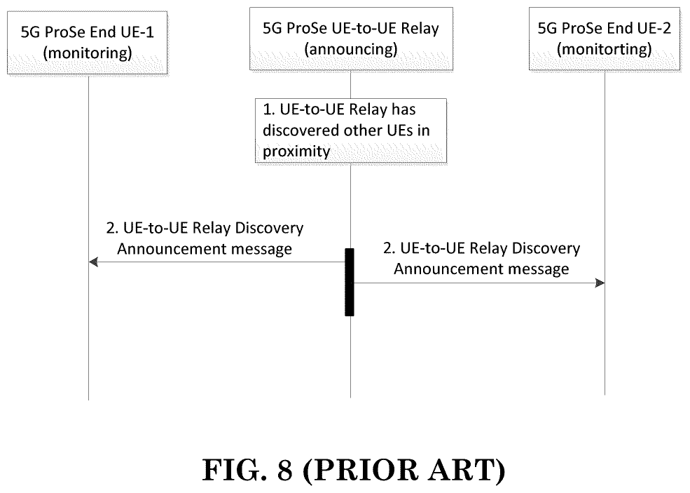

Depicted in Figure 6.3.2.4.2-1 is the procedure for 5G ProSe UE-to-UE Discovery with Model A.

[Figure 6.3.2.4.2-1 of 3GPP TS 23.304 V18.2.0, Entitled “5G ProSe UE-to-UE Relay Discovery with Model A”, is Reproduced as FIG. 8]

1. The 5G ProSe UE-to-UE Relay has discovered other UEs in proximity (e.g. via a previous 5G ProSe UE-to-UE Relay Discovery or 5G ProSe UE-to-UE Relay Communication procedures). The 5G ProSe UE-to-UE Relay obtains the User Info ID of other UEs in proximity per RSC.

2. The 5G ProSe UE-to-UE Relay sends a UE-to-UE Relay Discovery Announcement message. The UE-to-UE Relay Discovery Announcement message contains the Type of Discovery Message, User Info ID of the 5G ProSe UE-to-UE Relay, RSC and list of User Info ID of the 5G ProSe End UEs and is sent using the Source Layer-2 ID and Destination Layer-2 ID as described in clause 5.8.4.

The 5G ProSe UE-to-UE Relay shall only announce User Info IDs of other UEs in proximity which provided relay_indication when they were previously discovered.

A 5G ProSe End UE monitors announcement messages from a 5G ProSe UE-to-UE Relay. The 5G ProSe End UEs determine the Destination Layer-2 ID for signalling reception as specified in clause 5.1.

6.3.2.4.3 Procedure for 5G ProSe UE-to-UE Relay Discovery with Model B

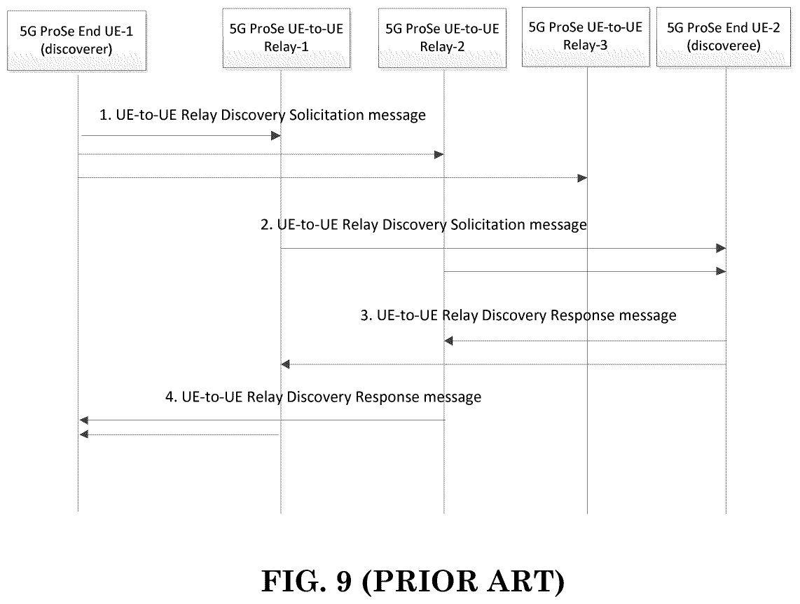

Depicted in FIG. 6.3.2.4.3-1 is the procedure for 5G ProSe UE-to-UE Relay Discovery with Model B.

[Figure 6.3.2.4.3-1 of 3GPP TS 23.304 V18.2.0, Entitled “5G ProSe UE-to-UE Relay Discovery with Model B”, is Reproduced as FIG. 9]

1. The discoverer 5G ProSe End UE (UE-1) sends a 5G ProSe UE-to-UE Relay Discovery Solicitation message. The 5G ProSe UE-to-UE Relay Discovery Solicitation message contains the Type of Discovery Message, User Info ID of itself, RSC, and User Info ID of the discoveree 5G ProSe End UE (UE-2), and is sent using the Source Layer-2 ID and Destination Layer-2 ID as described in clause 5.8.4.

A 5G ProSe UE-to-UE Relays determine the Destination Layer-2 ID for signalling reception as specified in clause 5.1.

2. A 5G ProSe UE-to-UE Relay that matches the RSC sends a 5G ProSe UE-to-UE Relay Discovery Solicitation message. The 5G ProSe UE-to-UE Relay Discovery Solicitation message contains the Type of Discovery Message, User Info ID of the discoverer 5G ProSe End UE (UE-1), User Info ID of UE-to-UE Relay, RSC, and User Info ID of the discoveree 5G ProSe End UE (UE-2) and is sent using the Source Layer-2 ID and Destination Layer-2 ID as described in clause 5.8.4.

A 5G ProSe End UE determines the Destination Layer-2 ID for signalling reception as specified in clause 5.1.

3. The discoveree 5G ProSe End UE (UE-2) that matches the value of RSC and the User Info ID of the discoveree 5G ProSe End UE (UE-2) responds to the 5G ProSe UE-to-UE Relay with a 5G ProSe UE-to-UE Relay Discovery Response message. The 5G ProSe UE-to-UE Relay Discovery Response message contains the Type of Discovery Message, RSC, User Info ID of the discoverer 5G ProSe End UE (UE-1), and User Info ID of itself, and is sent using the Source Layer-2 ID and Destination Layer-2 ID as described in clause 5.8.4. If the discoveree 5G ProSe End UE (UE-2) receives multiple UE-to-UE Relay Discovery Solicitation messages from different 5G ProSe UE-to-UE Relays, it may choose to respond or not to a 5G ProSe UE-to-UE Relay (e.g. based on the PC5 signal strength of each message received).

4. The 5G ProSe UE-to-UE Relay sends a 5G ProSe UE-to-UE Relay Discovery Response message. The 5G ProSe UE-to-UE Relay Discovery Response message contains the Type of Discovery Message, User Info ID of UE-to-UE Relay, RSC, and User Info ID of the discoveree 5G ProSe End UE (UE-2), and is sent using the Source Layer-2 ID and Destination Layer-2 ID as described in clause 5.8.4.

[ . . . ]

### 6.4.3.1 Layer-2 Link Establishment Over PC5 Reference Point

To perform unicast mode of ProSe Direct communication over PC5 reference point, the UE is configured with the related information as described in clause 5.1.3.

Figure 6.4.3.1-1 shows the layer-2 link establishment procedure for the unicast mode of ProSe Direct communication over PC5 reference point.

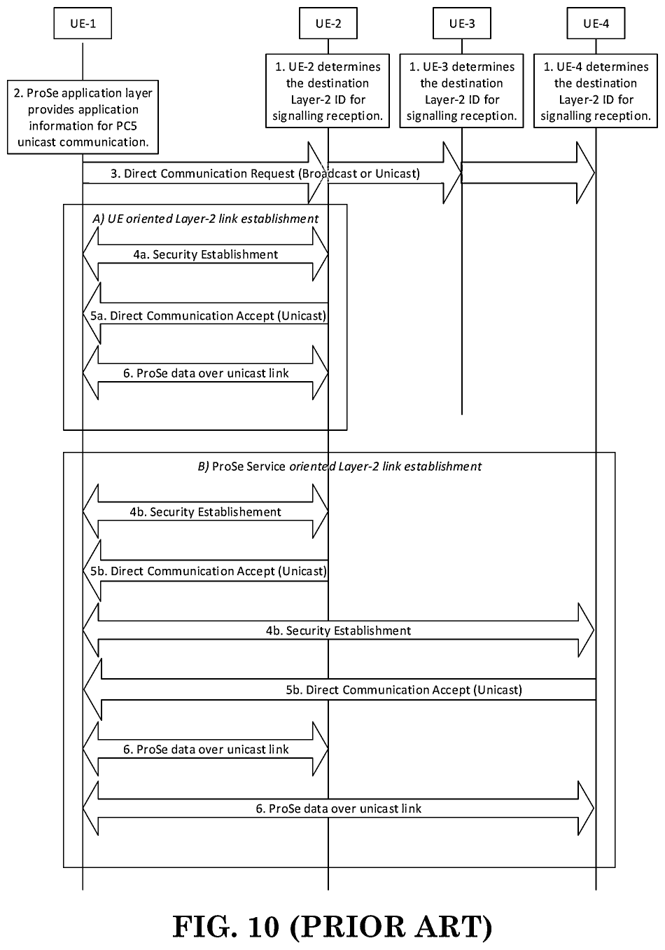

### [Figure 6.4.3.1-1 of 3GPP TS 23.304 V18.2.0, Entitled “Layer-2 Link Establishment Procedure”, is Reproduced FIG. 10]

1. The UE(s) determine the destination Layer-2 ID for signalling reception for PC5 unicast link establishment as specified in clause 5.8.2.4.

2. The ProSe application layer in UE-1 provides application information for PC5 unicast communication. The application information includes the ProSe Service Info, UE's Application Layer ID. The target UE's Application Layer ID may be included in the application information.

The ProSe application layer in UE-1 may provide ProSe Application Requirements for this unicast communication. UE-1 determines the PC5 QoS parameters and PFI as specified in clause 5.6.1.

If UE-1 decides to reuse the existing PC5 unicast link as specified in clause 5.3.4, the UE triggers the Layer-2 link modification procedure as specified in clause 6.4.3.4.

3. UE-1 sends a Direct Communication Request message to initiate the unicast layer-2 link establishment procedure. The Direct Communication Request message includes:
Source User Info: the initiating UE's Application Layer ID (i.e. UE-1's Application Layer ID).
If the ProSe application layer provided the target UE's Application Layer ID in step 2, the following information is included:
   Target User Info: the target UE's Application Layer ID (i.e. UE-2's Application Layer ID).
ProSe Service Info: the information about the ProSe identifier(s) requesting Layer-2 link establishment.
Security Information: the information for the establishment of security.

NOTE 1: The Security Information and the necessary protection of the Source User Info and Target User Info are defined by SA WG3.

The source Layer-2 ID and destination Layer-2 ID used to send the Direct Communication Request message are determined as specified in clauses 5.8.2.1 and 5.8.2.4. The destination Layer-2 ID may be broadcast or unicast Layer-2 ID. When unicast Layer-2 ID is used, the Target User Info shall be included in the Direct Communication Request message.

UE-1 sends the Direct Communication Request message via PC5 broadcast or unicast using the source Layer-2 ID and the destination Layer-2 ID.

A default PC5 DRX configuration may be used for transmitting and receiving of this message (see TS 38.300 [12]).

4. Security with UE-1 is established as below:
4a. If the Target User Info is included in the Direct Communication Request message, the target UE, i.e. UE-2, responds by establishing the security with UE-1.
4b. If the Target User Info is not included in the Direct Communication Request message, the UEs that are interested in using the announced ProSe Service(s) over a PC5 unicast link with UE-1 responds by establishing the security with UE-1.

NOTE 2: The signalling for the Security Procedure is defined by SA WG3.

When the security protection is enabled, UE-1 sends the following information to the target UE:
If IP communication is used:
   IP Address Configuration: For IP communication, IP address configuration is required for this link and indicates one of the following values:
      “DHCPv4 server” if only IPv4 address allocation mechanism is supported by the initiating UE, i.e., acting as a DHCPv4 server; or
      “IPv6 Router” if only IPv6 address allocation mechanism is supported by the initiating UE, i.e., acting as an IPv6 Router; or
      “DHCPv4 server & IPv6 Router” if both IPv4 and IPv6 address allocation mechanism are supported by the initiating UE; or
      “address allocation not supported” if neither IPv4 nor IPv6 address allocation mechanism is supported by the initiating UE.
   Link-Local IPv6 Address: a link-local IPv6 address formed locally based on RFC 4862 if UE-1 does not support the IPv6 IP address allocation mechanism, i.e. the IP Address Configuration indicates “address allocation not supported”.
QoS Info: the information about PC5 QoS Flow(s). For each PC5 QoS Flow, the PFI and the corresponding PC5 QoS parameters (i.e. PQI and conditionally other parameters such as MFBR/GFBR, etc.) and optionally the associated ProSe identifier(s).
Optional PC5 QoS Rule(s).

The source Layer-2 ID used for the security establishment procedure is determined as specified in clauses 5.8.2.1 and 5.8.2.4. The destination Layer-2 ID is set to the source Layer-2 ID of the received Direct Communication Request message.

Upon receiving the security establishment procedure messages, UE-1 obtains the peer UE's Layer-2 ID for future communication, for signalling and data traffic for this unicast link.

5. A Direct Communication Accept message is sent to UE-1 by the target UE(s) that has successfully established security with UE-1:
5a. (UE oriented Layer-2 link establishment) If the Target User Info is included in the Direct Communication Request message, the target UE, i.e. UE-2 responds with a Direct Communication Accept message if the Application Layer ID for UE-2 matches.
5b. (ProSe Service oriented Layer-2 link establishment) If the Target User Info is not included in the Direct Communication Request message, the UEs that are interested in using the announced ProSe Service(s) respond to the request by sending a Direct Communication Accept message (UE-2 and UE-4 in Figure 6.4.3.1-1).

The Direct Communication Accept message includes:
Source User Info: Application Layer ID of the UE sending the Direct Communication Accept message.
QoS Info: the information about PC5 QoS Flow(s). For each PC5 QoS Flow, the PFI and the corresponding PC5 QoS parameters requested by UE-1 (i.e. PQI and conditionally other parameters such as MFBR/GFBR, etc.) and optionally the associated ProSe identifiers(s).
Optional PC5 QoS Rule(s).
If IP communication is used:
   IP Address Configuration: For IP communication, IP address configuration is required for this link and indicates one of the following values:
      “DHCPv4 server” if only IPv4 address allocation mechanism is supported by the target UE, i.e., acting as a DHCPv4 server; or
      “IPv6 Router” if only IPv6 address allocation mechanism is supported by the target UE, i.e., acting as an IPv6 Router; or
      “DHCPv4 server & IPv6 Router” if both IPv4 and IPv6 address allocation mechanism are supported by the target UE; or
      “address allocation not supported” if neither IPv4 nor IPv6 address allocation mechanism is supported by the target UE.
   Link-Local IPv6 Address: a link-local IPv6 address formed locally based on RFC 4862 if the target UE does not support the IPv6 IP address allocation mechanism, i.e. the IP Address Configuration indicates “address allocation not supported”, and UE-1 included a link-local IPv6 address in the Direct Communication Request message. The target UE shall include a non-conflicting link-local IPv6 address.

If both UEs (i.e. the initiating UE and the target UE) are selected to use link-local IPv6 address, they shall disable the duplicate address detection defined in RFC 4862 [17].

NOTE 3: When either the initiating UE or the target UE indicates the support of IPv6 routing, the corresponding address configuration procedure would be carried out after the establishment of the layer 2 link, and the link-local IPv6 addresses are ignored.

The ProSe layer of the UE that established PC5 unicast link passes the PC5 Link Identifier assigned for the unicast link and the PC5 unicast link related information down to the AS layer. The PC5 unicast link related information includes Layer-2 ID information (i.e. source Layer-2 ID and destination Layer-2 ID). This enables the AS layer to maintain the PC5 Link Identifier together with the PC5 unicast link related information.

Two UEs may negotiate the PC5 DRX configuration in the AS layer, and the PC5 DRX parameter values can be configured per pair of source and destination Layer-2 IDs in the AS layer.

6. ProSe data is transmitted over the established unicast link as below:

The PC5 Link Identifier and PFI are provided to the AS layer, together with the ProSe data. Optionally in addition, the Layer-2 ID information (i.e. source Layer-2 ID and destination Layer-2 ID) is provided to the AS layer.

NOTE 4: It is up to UE implementation to provide the Layer-2 ID information to the AS layer. UE-1 sends the ProSe data using the source Layer-2 ID (i.e. UE-1's Layer-2 ID for this unicast link) and the destination Layer-2 ID (i.e. the peer UE's Layer-2 ID for this unicast link).

NOTE 5: PC5 unicast link is bi-directional, therefore the peer UE of UE-1 can send the ProSe data to UE-1 over the unicast link with UE-1.

[ . . . ]

### 6.4.3.7 Layer-2 Link Management Over PC5 Reference Point for 5G ProSe UE-to-UE Relay

### 6.4.3.7.1 Common Part for Layer-2 Link Management Over PC5 Reference Point for 5G ProSe UE-to-UE Relay

For the 5G ProSe Communication via 5G ProSe UE-to-UE Relay as described in clause 6.7.1 and clause 6.7.2:
The Direct Communication Request message over the first hop PC5 reference point includes:
   User Info ID of source 5G ProSe End UE: the identity of the source 5G ProSe End UE requesting relay operation (i.e. User Info ID).
   User Info ID of 5G ProSe UE-to-UE Relay: the identity of the UE-to-UE Relay provided to the source 5G ProSe End UE during 5G ProSe UE-to-UE Relay Discovery procedure (i.e. User Info ID).
   User Info ID of target 5G ProSe End UE: the identity of the target 5G ProSe End UE provided to the source 5G ProSe End UE during UE-to-UE Relay Discovery procedure (i.e. User Info ID).
   (optional) Destination Layer-2 ID of target 5G ProSe End UE: the unicast destination Layer-2 ID of the target 5G ProSe End UE determined by the source 5G ProSe End UE as specified in clause 5.8.2.4.
   ProSe Service Info: the information about the ProSe identifier(s) requesting Layer-2 link establishment.
   RSC: the connectivity service provided by the 5G ProSe UE-to-UE Relay as requested by the source 5G ProSe End UE.
   Security Information: the information for the establishment of security for the first hop PC5 link establishment.

NOTE 1: The Security Information is defined by SA WG3.

The Direct Communication Request message over the second hop PC5 reference point includes:
User Info ID of source 5G ProSe End UE.
User Info ID of target 5G ProSe End UE.
User Info ID of 5G ProSe UE-to-UE Relay.
ProSe Service Info: the information about the ProSe identifier(s).
RSC: the connectivity service provided by the 5G ProSe UE-to-UE Relay as requested by the source 5G ProSe End UE.
Security Information: the information for the establishment of security for the second hop PC5 link establishment.

NOTE 2: The Security Information is defined by SA WG3.

The Direct Communication Accept message over the second hop PC5 reference point includes:
User Info ID of target 5G ProSe End UE.

The Direct Communication Accept message over the first hop PC5 reference point includes:
User Info ID of target 5G ProSe End UE.
User Info ID of 5G ProSe UE-to-UE Relay.

The Link Modification Request message over the first hop PC5 reference point includes:
User Info ID of target 5G ProSe End UE: the identity of the target 5G ProSe End UE provided to the source 5G ProSe End UE during UE-to-UE Relay Discovery procedure.
(optional) Destination Layer-2 ID of target 5G ProSe End UE: the unicast destination Layer-2 ID of the target 5G ProSe End UE determined by the source 5G ProSe End UE as specified in clause 5.8.2.4.

The Link Modification Request message over the second hop PC5 reference point includes:
User Info ID of source 5G ProSe End UE.
User Info ID of target 5G ProSe End UE.

The Link Modification Accept message over the second hop PC5 reference point includes:
User Info ID of target 5G ProSe End UE.

The Link Modification Accept message over the first hop PC5 reference point includes:
User Info ID of target 5G ProSe End UE.
   6.4.3.7.2 Layer-2 link Management Over PC5 Reference Point for 5G ProSe Layer-2 UE-to-UE Relay

For the 5G ProSe Communication via 5G ProSe Layer-2 UE-to-UE Relay as described in clause 6.7.2, the description in clause 6.4.3.7.1 applies.

The message contents over PC5 reference point for unicast mode 5G ProSe Direct Communication as depicted from clause 6.4.3.1 to clause 6.4.3.5 are same for the end-to-end connection between peer 5G ProSe End UEs.

[ . . . ]

6.4.3.7.4 Layer-2 Link Management Over PC5 Reference Point for 5G ProSe UE-to-UE Relay Communication with Integrated Discovery

This clause is for the 5G ProSe UE-to-UE Relay Communication with integrated Discovery procedure as described in clause 6.7.3.

The Direct Communication Request message over the first hop PC5 reference point includes:
User Info ID of source 5G ProSe End UE.
(optional) User Info ID of target 5G ProSe End UE: the identity of the target 5G ProSe End UE if provided from the ProSe application layer.
(optional) Destination Layer-2 ID of target 5G ProSe End UE: the unicast destination Layer-2 ID of the target 5G ProSe End UE determined by the source 5G ProSe End UE as specified in clause 5.8.2.4.
ProSe Service Info: the information about the ProSe identifier(s) requesting Layer-2 link establishment.
RSC: the connectivity service provided by the 5G ProSe UE-to-UE Relay as requested by the source 5G ProSe End UE.
Relay_indication: indicates whether the Direct Communication Request message can be forwarded by a 5G ProSe UE-to-UE Relay.
Security Information: the information for the establishment of security for the first hop PC5 link establishment.

NOTE 1: The Security Information is defined by SA WG3.

The Direct Communication Request message over the second hop PC5 reference point includes:
User Info ID of source 5G ProSe End UE.
User Info ID of 5G ProSe UE-to-UE Relay.
(optional) User Info ID of target 5G ProSe End UE.
ProSe Service Info: the information about the ProSe identifier(s).
RSC: the connectivity service provided by the 5G ProSe UE-to-UE Relay as requested by the source 5G ProSe End UE.
Security Information: the information for the establishment of security for the second hop PC5 link establishment.

NOTE 2: The Security Information is defined by SA WG3.

The Direct Communication Accept message over the second hop PC5 reference point includes:
User Info ID of target 5G ProSe End UE.

The Direct Communication Accept message over the first hop PC5 reference point includes:
User Info ID of target 5G ProSe End UE.
User Info ID of 5G ProSe UE-to-UE Relay.

For the 5G ProSe Communication via 5G ProSe Layer-3 UE-to-UE Relay, additional clarifications are as following:
In the Security Procedure of the second hop PC5 reference point, the 5G ProSe Layer-3 UE-to-UE Relay provides the IP Address Configuration or Link-Local IPv6 Address to the target 5G ProSe End UE.
The Direct Communication Accept message over the second hop PC5 reference point additionally includes IP Address Configuration or Link-Local IPv6 Address (if IP communication is used), Ethernet MAC address of target 5G ProSe End UE (if Ethernet communication is used). QoS Info is not included in the Security Procedure or Direct Communication Accept message of the second hop PC5 reference point.
In the Security Procedure of the first hop PC5 reference point, the source 5G ProSe End UE provides the IP Address Configuration, Link-Local IPv6 Address and QoS Info of the end-to-end QoS to the 5G ProSe Layer-3 UE-to-UE Relay.
The 5G ProSe Layer-3 UE-to-UE Relay provides the QoS info of the second hop QoS to the target 5G ProSe End UE using the Layer-2 link modification as described in the clause 6.4.3.4.
The 5G ProSe Layer-3 UE-to-UE Relay decides the QoS Info of the first hop QoS with considering the received second hop QoS from the target 5G ProSe End UE, the Direct Communication Accept message over the first hop PC5 reference point additionally includes IP Address Configuration or Link-Local IPv6 Address, QoS Info of the first hop QoS and may include IP address of the target 5G ProSe End UE (if IP communication is used) or Ethernet MAC address of target 5G ProSe End UE (if Ethernet communication is used).

For the 5G ProSe Communication via 5G ProSe Layer-2 UE-to-UE Relay, the message contents over PC5 reference point for unicast mode 5G ProSe Direct Communication as depicted from clause 6.4.3.1 to clause 6.4.3.5 are same for the end-to-end connection between peer 5G ProSe End UEs.

[. . . ]

### 6.7.3 5G ProSe UE-to-UE Relay Communication with Integrated Discovery

### 6.7.3.1 General

5G ProSe Communication via 5G ProSe UE-to-UE Relay with integrated Discovery is supported. For 5G ProSe UE-to-UE Relay Communication with integrated Discovery, when a UE allows a UE-to-UE relay to be involved in the Direct Communication Request to the other UE, the UE indicates it by including a relay_indication in the broadcasted Direct Communication Request message.

When a UE-to-UE relay receives a Direct Communication Request including a relay_indication, it decides whether to forward the message according to e.g. Relay Service Code if there is any, Application ID, operator policy per Relay Service Code, signal strength, and local policy.

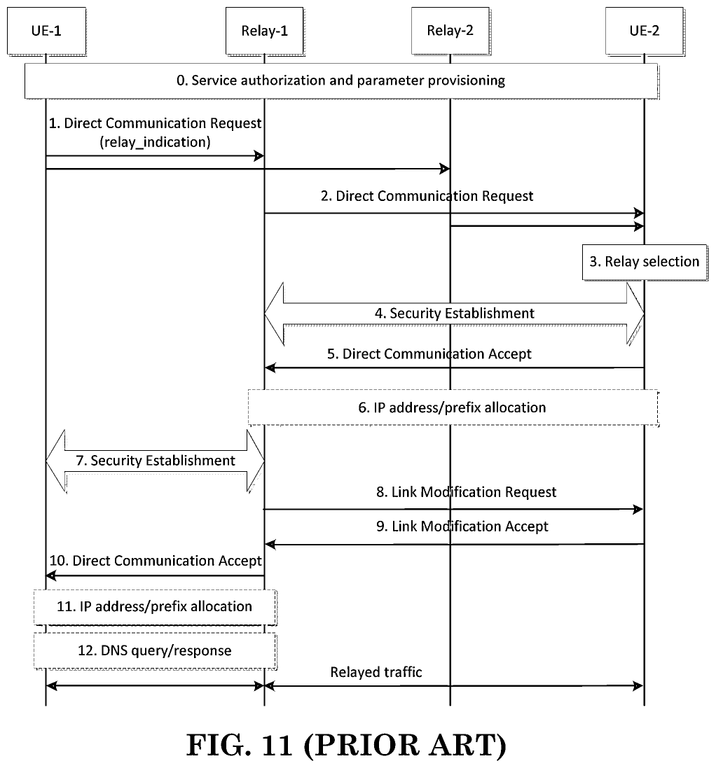

### 6.7.3.2 Procedure for Communication Via Layer-3 UE-to-UE Relay

[Figure 6.7.3.2-1 of 3GPP TS 23.304 V18.2.0, Entitled “5G ProSe UE-to-UE Relay Communication with Integrated Discovery Via Layer-3 UE-to-UE Relay”, is Reproduced as FIG. 11]

0. 5G ProSe End UEs are authorized and provisioned with parameters to use the service provided by the 5G ProSe UE-to-UE Relays. 5G ProSe UE-to-UE Relays are authorized and provisioned with parameters to provide service of relaying traffic among 5G ProSe End UEs.

1. The source 5G ProSe End UE (i.e. UE-1) wants to establish a unicast communication with the target 5G ProSe End UE (i.e. UE-2) and broadcasts a Direct Communication Request. The parameters included in the Direct Communication Request message are described in clause 6.4.3.7.

The relay_indication in the Direct Communication Request is used to indicate whether 5G ProSe UE-to-UE Relay can forward the Direct Communication Request message or not. It is also used to limit the number of hops of 5G ProSe UE-to-UE Relay by removing relay_indication in the Direct Communication Request message from the 5G ProSe UE-to-UE Relay.

The Source Layer-2 ID and Destination Layer-2 ID used for the Direct Communication Request message are defined in clause 5.8.5.

NOTE 1: The data type of relay_indication can be determined in Stage 3.

2. When receiving Direct Communication Request with relay_indication from UE-1, the 5G ProSe UE-to-UE Relay (i.e. Relay-1 and Relay-2) may decide to participate in the procedure and broadcast a Direct Communication Request message in its proximity without relay_indication. The parameters included in the Direct Communication Request message are described in clause 6.4.3.7.

The Source Layer-2 ID and Destination Layer-2 ID used for the Direct Communication Request message are defined in clause 5.8.5.

3. When UE-2 receives a Direct Communication Request from one or multiple 5G ProSe UE-to-UE Relays, UE-2 select a 5G ProSe UE-to-UE Relay which UE-2 will respond. UE-2 may select the 5G ProSe UE-to-UE Relay according to e.g. the signal strength, local policy, operator policy per Relay Service Code if any.

4. The security establishment happens between UE-2 and the selected 5G ProSe UE-to-UE Relay (here Relay-1), if needed.

If the existing PC5 link can be reused, Link Modification Request and Link Modification Accept messages are used.

NOTE 2: The conflict between Link Modification Request and Direct Communication Request can be determined in Stage 3.

5. UE-2 replies Direct Communication Accept message to Relay-1. The parameters included in the Direct Communication Accept message are described in clause 6.4.3.7.

6. For IP traffic, IPv6 prefix or IPv4 address is allocated for the target 5G ProSe Layer-3 End UE as defined in clause 5.5.1.4.

7. Security establishment happens between UE-1 and Relay-1, if needed.

8. For 5G ProSe UE-to-UE Relay Communication with integrated Discovery, after receiving QoS Info of the end-to-end QoS from UE-1, Relay-1 provides the QoS info of the second hop QoS to UE-2 with Link Modification Request message.

9. For 5G ProSe UE-to-UE Relay Communication with integrated Discovery, UE-2 responds with a Link Modification Accept message.

10. Relay-1 responds with Direct Communication Accept to the UE-1. The parameters included in the Direct Communication Accept message are described in clause 6.4.3.7.

11. For IP traffic, IPv6 prefix or IPv4 address is allocated for the source 5G ProSe Layer-3 End UE as defined in clause 5.5.1.4.

12. For IP communication, the 5G ProSe Layer-3 UE-to-UE Relay may store an association of User Info ID and the IP address of target 5G ProSe Layer-3 End UE into its DNS entries, and the 5G ProSe Layer-3 UE-to-UE Relay may act as a DNS server to other UEs. The source 5G ProSe Layer-3 End UE may send a DNS query to the 5G ProSe Layer-3 UE-to-UE Relay to request IP address of target 5G ProSe Layer-3 End UE after step 11 if the IP address of target 5G ProSe Layer-3 End UE is not received in step 10, and the 5G ProSe Layer-3 UE-to-UE Relay returns the IP address of the target 5G ProSe Layer-3 End UE to the source 5G ProSe Layer-3 End UE.

For Ethernet communication, the 5G ProSe Layer-3 UE-to-UE Relay is acting as an Ethernet switch by maintaining the association between PC5 links and Ethernet MAC addresses received from the 5G ProSe Layer-3 End UE.

For Unstructured traffic communication, for each pair of source and target 5G ProSe Layer-3 End UEs, the 5G ProSe Layer-3 UE-to-UE Relay maintains the 1:1 mapping between the PC5 link with source 5G ProSe Layer-3 End UE and the PC5 link with target 5G ProSe Layer-3 End UE.

The source 5G ProSe Layer-3 End UE communicates with the target 5G ProSe Layer-3 End UE via the 5G ProSe Layer-3 UE-to-UE Relay.

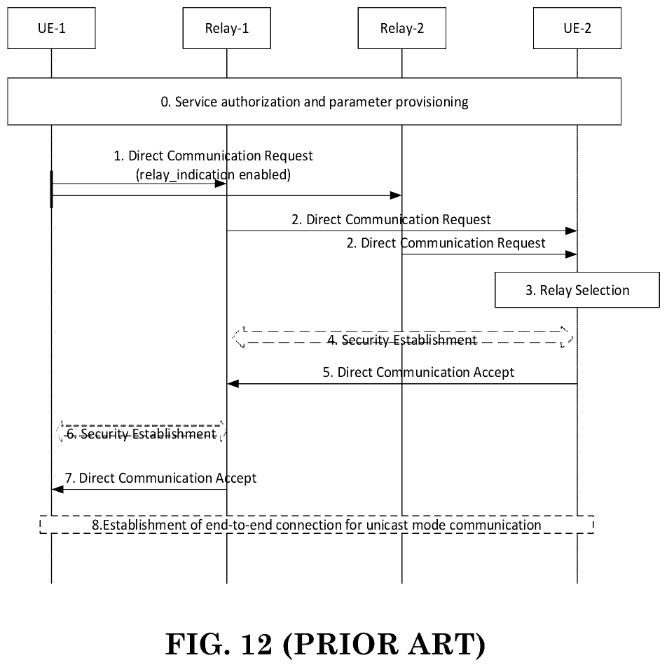

### 6.7.3.3 Procedure for Communication Via Layer-2 UE-to-UE Relay

[Figure 6.7.3.3-1 of 3GPP TS 23.304 V18.2.0, Entitled “5G ProSe UE-to-UE Relay Communication with Integrated Discovery via Layer-2 UE-to-UE Relay”, is reproduced FIG. 12]

Step 0-step 5 are same as step 0-step 5 of Figure 6.7.3.2-1. Step 6 is same as step 7 of Figure 6.7.3.2-1. Step 7 is the same as step 10 of Figure 6.7.3.2-1. The parameters included in the messages are described in clause 6.4.3.7.

8. For 5G ProSe UE-to-UE Relay Communication via Layer-2 UE-to-UE Relay, UE-1 establishes an end-to-end connection for unicast mode communication with UE-2 as described in clause 6.4.3.7.
Editor's note: Any additional update of procedure via Layer-2 UE-to-UE Relay, e.g. according to RAN's decision, will be included here.

Section 6.2.14.2 of 3GPP TS 24.554 specifies a UE may include the relay indication in a PROSE PC5 DISCOVERY message (e.g. a Direct Discovery Announcement, a Direct Discovery Solicitation, a Direct Discovery Response) to indicate whether the 5G ProSe UE-to-UE relay UE(s) can broadcast its user info ID during the procedure of 5G ProSe UE-to-UE relay discovery over PC5 interface if the UE can act as a 5G ProSe end UE. In addition, the relay indication may also be included in a PROSE DIRECT LINK ESTABLISHMENT REQUEST message to indicate whether the 5G ProSe UE-to-UE relay UE(s) can broadcast its user info ID during the procedure of 5G ProSe direct link establishment procedure (with integrated Discovery) over PC5 interface if the UE can act as a 5G ProSe end UE, according to section 7.2.2.2 of 3GPP TS 24.554. The relay indication (RI) included in these messages is one-bit value described in section 11.2.16 of 3GPP TS 24.554 as follows:

### 11.2.16 Relay Indication

The relay indication parameter is used to indicate whether the 5G ProSe UE-to-UE relay UE(s) can rebroadcast the user info ID of the UE who generates the corresponding message including the relay indication during the procedure of 5G ProSe UE-to-UE relay discovery over PC5 interface.

The relay indication is a type 1 information element with a length of 1 octet.

The relay indication IE is coded as shown in Figure 11.2.y.1 and table 11.2.y.1.

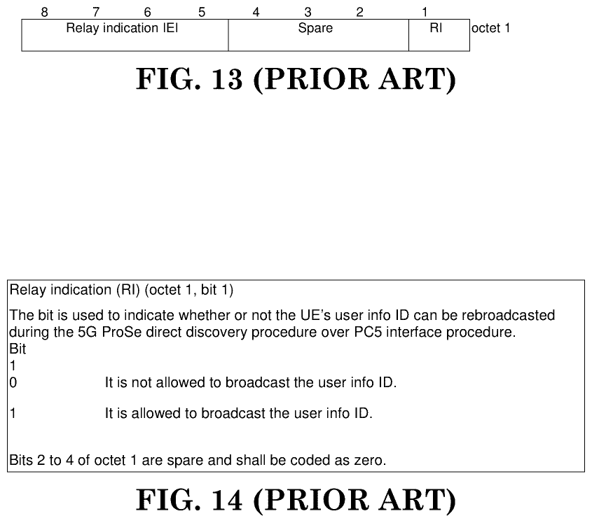

### [Figure 11.2.y.1 of 3GPP TS 24.554 V18.1.0, Entitled “Relay Indication Information Element”, is Reproduced as FIG. 13]

[Table 11.2.y.1 of 3GPP TS 24.554 V18.1.0, Entitled “Relay Indication Information Element”, is reproduced as FIG. 14]

3GPP TS 22.261 specifies connectivity models and KPIs for UE to network relaying in 5G system as follows:

### 6.9 Connectivity Models

### 6.9.1 Description

The UE (remote UE) can connect to the network directly (direct network connection), connect using another UE as a relay UE (indirect network connection), or connect using both direct and indirect connections. Relay UEs can be used in many different scenarios and verticals (inHome, SmartFarming, SmartFactories, Public Safety and others). In these cases, the use of relays UEs can be used to improve the energy efficiency and coverage of the system.

Remote UEs can be anything from simple wearables, such as sensors embedded in clothing, to a more sophisticated wearable UE monitoring biometrics. They can also be non-wearable UEs that communicate in a Personal Area Network such as a set of home appliances (e.g. smart thermostat and entry key), or the electronic UEs in an office setting (e.g. smart printers), or a smart flower pot that can be remotely activated to water the plant.

When a remote UE is attempting to establish an indirect network connection, there might be several relay UEs that are available in proximity and supporting selection procedures of an appropriate relay UE among the available relay UEs is needed.

Indirect network connection covers the use of relay UEs for connecting a remote UE to the 3GPP network. There can be one or more relay UE(s) (more than one hop) between the network and the remote UE.

A ProSe UE-to-UE Relay can also be used to connect two remote Public Safety UEs using direct device connection. There can be one or more ProSe UE-to-UE Relay(s) (more than one hop) between the two remote Public Safety UEs.

### 6.9.2 Requirements

The following set of requirements complement the requirements listed in 3GPP TS 22.278 [5], clauses 7B and 7C.

### 6.9.2.1 General

The 5G system shall support the relaying of traffic between a remote UE and a gNB using one or more relay UEs.

The 5G system shall support same traffic flow of a remote UE to be relayed via different indirect network connection paths.

The 5G system shall support different traffic flows of a remote UE to be relayed via different indirect network connection paths.

The connection between a remote UE and a relay UE shall be able to use 3GPP RAT or non-3GPP RAT and use licensed or unlicensed band.

The connection between a remote UE and a relay UE shall be able to use fixed broadband technology.

The 5G system shall support indirect network connection mode in a VPLMN when a remote UE and a relay UE subscribe to different PLMNs and both PLMNs have a roaming agreement with the VPLMN.

The 5G system shall be able to support a UE using simultaneous indirect and direct network connection mode.

The network operator shall be able to define the maximum number of hops supported in their networks when using relay UEs.

The 5G system shall be able to manage communication between a remote UE and the 5G network across multi-path indirect network connections.

3GPP TS 23.304 introduces UE-to-UE Relay in Release 18. For single hop UE-to-UE Relay, a UE-to-UE relay may be used to support data communication between two remote UEs in case these two remote UEs cannot communicate with each other directly. A UE-to-UE relay needs to establish one PC5 unicast link (or PC5 RRC connection) with each of a source remote UE and a target remote UE. In case of Layer-2 UE-to-UE Relay, an end-to-end link (or connection) for unicast communication may be established between these two remote UEs after the previous two PC5 unicast links have been established between the UE-to-UE relay and two remote UEs.

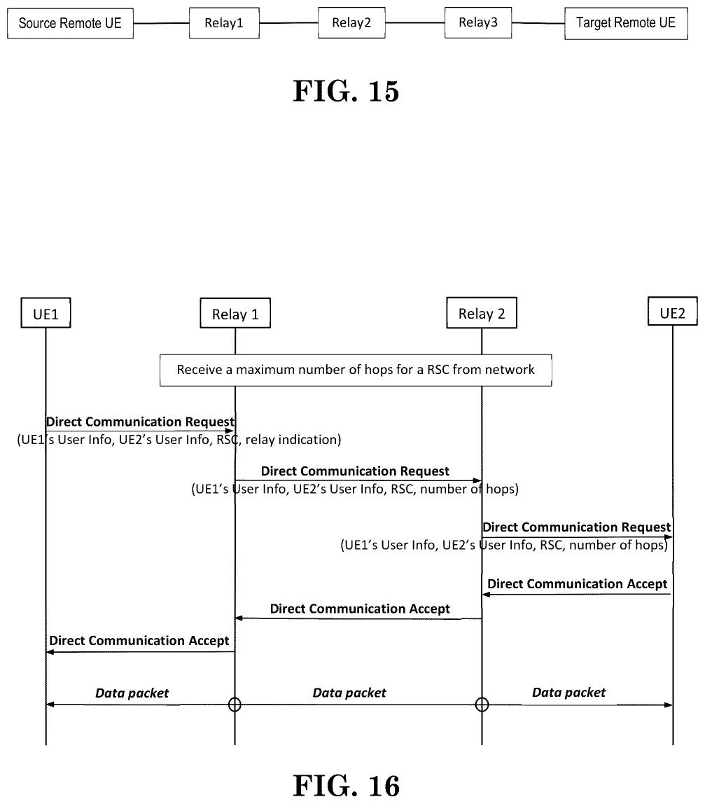

According to 3GPP TS 22.261, multi-hop UE-to-UE Relay may be supported in Release 19. FIG. 15 illustrates an exemplary 3-hop UE-to-UE Relay according to one exemplary embodiment. And, the network operator shall be able to define the maximum number of hops supported in their networks when using relay UEs.

Considering that the more hops used, the more delay induced, it is not appropriate for the network to configure one value of the maximum number of hops for services with different Quality of Service (QoS) requirements. Therefore, it is beneficial for the network to configure the maximum number of hops based on services. For example, the network may provide the maximum number of hop for each (ProSe) Relay Service Code (RSC) or each (ProSe) service to a relay UE so as to limit the maximum number of hops used for multi-hop UE-to-UE Relay. Alternatively, the network may provide the mapping of maximum number of hops to (ProSe) RSCs or (ProSe) services to a relay UE. It is possible that one or multiple (ProSe) services may be mapped to one (ProSe) RSC, where a RSC indicates the connectivity service the UE-to-UE relay provides to the remote UE. In addition, each (ProSe) service may be identified by an application ID.

Section 6.7.3 of 3GPP TS 23.204 V18.2.0 describes 5G ProSe Communication via 5G ProSe UE-to-UE Relay with integrated Discovery for single hop UE-to-UE Relay. Basically, when a remote UE (e.g., UE-1) allows a UE-to-UE relay to be involved in the Direct Communication Request to the other remote UE, the remote UE (UE-1) indicates it by including a relay_indication in the broadcasted Direct Communication Request message. When a UE-to-UE relay receives a Direct Communication Request message including a relay_indication, it decides whether to forward the message (more precisely whether to broadcast the user info of UE-1 in another Direct Communication Request message) according to e.g. Relay Service Code if there is any, Application ID, operator policy per Relay Service Code, signal strength, and local policy. When UE-2 receives a Direct Communication Request message from one or multiple UE-to-UE relays, UE-2 may select a UE-to-UE Relay according to the signal strength, local policy, and/or operator policy per Relay Service Code if any. Then, UE-2 may reply a Direct Communication Accept message to the selected UE-to-UE Relay (after security establishment between UE-2 and the selected UE-to-UE Relay, if needed). Before replying the Direct Communication Accept message, UE-2 may first initiate the security establishment procedure by transmitting a Security Mode Command to the selected UE-to-UE Relay.

After receiving the Direct Communication Accept message from UE-2, the UE-to-UE Relay may then transmit another Direct Communication Accept message to UE-1. In case of single hop UE-to-UE Relay, the Direct Communication Request message sent by a UE-to-UE relay may not include the relay_indication. Alternatively, the relay_indication may be set to a value indicating it is not allowed to broadcast the user info (or user info ID) of the source end UE.

Step 1 in Figure 6.7.3.2-1 of 3GPP TS.23.304 V18.2.0 also mentions that the relay_indication in the Direct Communication Request message can be used to limit the number of hops of UE-to-UE relay by removing relay_indication in the Direct Communication Request message broadcasted from the UE-to-UE Relay in case of multi-hop UE-to-UE Relay. To support this, there is a need for a UE-to-UE relay to include information, in the Direct Communication Request message, to indicate the accumulated number of hops or relays which are involved in multi-hop UE-to-UE Relay. When the maximum (accumulated) number of hops or relays is reached, the receiving UE-to-UE Relay may remove the relay_indication or set the relay_indication to a value indicating it is not allowed to broadcast the user info (or user info ID) of the source end UE.

This could be a new information element (IE), which indicates the accumulated number of hops or relays that are involved in the multi-hop UE-to-UE Relay. The first UE-to-UE relay may set the accumulated number to 1 when transmitting the Direct Communication Request message. And, the second UE-to-UE relay may set the accumulated number to “2”. The third UE-to-UE relay may remove the relay_indication or set the relay_indication to a value (e.g. 0) indicating it is not allowed to broadcast the user info (or user info ID) of the source end UE if the maximum (accumulated) number of hops or relays is 3. In this situation, the third UE-to-UE relay may not include the accumulated number in the Direct Communication Request message. It is also feasible to rely solely on the accumulated number of hops for a UE-to-UE relay to determine whether it is allowed to broadcast the user info (or user info ID) of the source end UE. For example, it is allowed to broadcast the user info (or user info ID) of the source end UE if the current accumulated number of hops (i.e. the received accumulated number of hops plus 1) is less than or equal to the maximum number of hops. Otherwise, it is not allowed. In the solution, the source end UE may not include the accumulated number in the Direct Communication Request message for transmission. Alternatively, the source end UE may set the accumulated number to “0” for transmitting the Direct Communication Request message.

It is also feasible to redefine the relay_indication to also indicate an accumulated number of hops or relays which are involved in the multi-hop UE-to-UE Relay. More specifically, the relay_indication may have two functions:
(1) one function is to indicate whether a UE-to-UE Relay can broadcast the user info of the source end UE in another Direct Communication Request message. For example, the relay_indication may be set to a specific value “x” (e.g. “0”) to indicate it is not allowed to broadcast the user info (or user info ID).
(2) the other is to indicate the accumulated number of hops or relays which are involved in the multi-hop UE-to-UE Relay. For example, the relay_indication may be set to values other than “x” (e.g. “1”, “2”, “3”, etc.) to indicate it is allowed to broadcast the user info (or user info ID) and this value also indicates the accumulated number of hops or relays, taking the receiving UE-to-UE Relay into account. In this situation, the source end UE may firstly set the relay_indication to “1” when transmitting the Direct Communication Request message. And, the first UE-to-UE relay may set the accumulated number to “2”.
It is also possible for the source end UE to set the relay_indication to “0” when transmitting the Direct Communication Request message and the first UE-to-UE relay may set the accumulated number to “1”, if a value other than “0” (e.g. a value of “15”, assuming 4 bits is used to represent the relay_indication) is used to indicate it is not allowed to broadcast the user info (or user info ID).

FIG. 16 illustrates an example of the above concept for multi-hop UE-to-UE Relay.

The above concept may also be applied to UE-to-UE Relay Discovery with Model B for a source remote UE to find a target remote UE. For example, a UE-to-UE relay may also include information indicating the accumulated number of hops or relays, involved in multi-hop UE-to-UE Relay, in a UE-to-UE Relay Discovery Solicitation message.

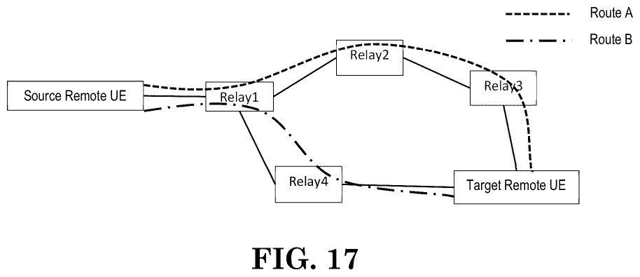

FIG. 17 illustrates an exemplary multi-route UE-to-UE Relay. As shown in FIG. 17, there may be multiple routes for the source remote UE to reach the target remote UE via different relay UEs. Route A has 3 hops and Route B has 2 hops, respectively. In this situation, it is beneficial in terms of transfer delay for the target remote UE to take the accumulated number of hops into consideration for relay UE (or route) selection. For example, the target remote UE may select Relay4 (i.e. Route B) for communicate with the source remote UE. In other words, the target remote UE may select a relay UE indicating a less (or smaller) accumulated number of hops when receiving Direct Communication Request messages or UE-to-UE Relay Discovery Solicitation messages from multiple relay UEs. Then, the target remote UE may transmit a Security Mode Command or a Direct Communication Accept message to the selected relay UE in response to reception of a Direct Communication Request message from the selected relay UE or transmit a UE-to-UE Relay Discovery Response message to the selected relay UE in response to reception of the UE-to-UE Relay Discovery Solicitation message from the selected relay UE. Other factor like signal strength (e.g. RSRP) with relay UE may also be taken into consideration for relay UE selection.

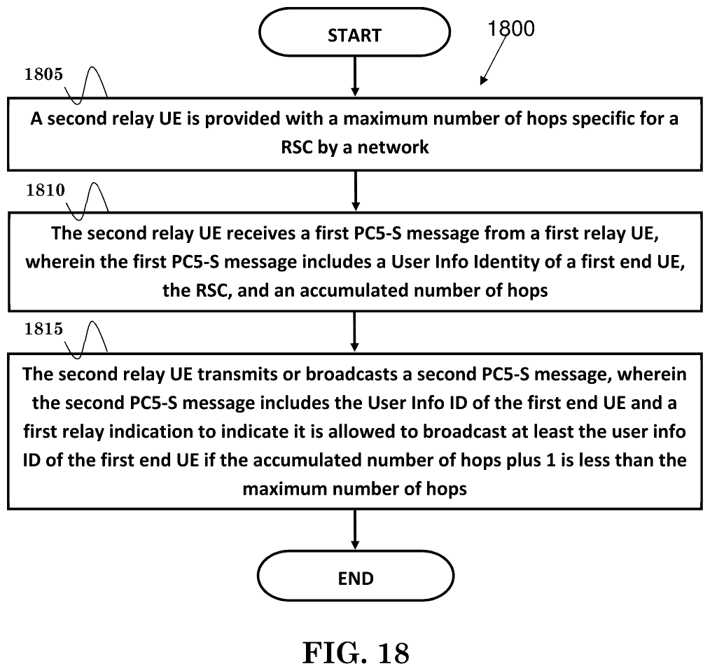

FIG. 18 is a flow chart 1800 of a method for supporting multi-hop UE-to-UE relay. In step 1805, a second relay UE is provided with a maximum number of hops specific for a Relay Service Code (RSC) by a network. In step 1810, the second relay UE receives a first PC5-S message from a first relay UE, wherein the first PC5-S message includes a User Info Identity (ID) of a first end UE, the RSC, and an accumulated number of hops. In step 1815, the second relay UE transmits or broadcasts a second PC5-S message, wherein the second PC5-S message includes the User Info ID of the first end UE and a first relay indication to indicate it is allowed to broadcast at least the user info ID of the first end UE if the accumulated number of hops plus 1 is less than the maximum number of hops.

In one embodiment, the second PC5-S message may include a second relay indication to indicate it is not allowed to broadcast at least the User Info ID of the first end UE if the accumulated number of hops plus 1 is equal to the maximum number of hops. In another embodiment, the second PC5-S message may not include the first relay indication if the accumulated number of hops plus 1 is equal to the maximum number of hops.

In one embodiment, the first PC5-S message may include another relay indication to indicate it is allowed to broadcast at least the User Info ID of the first end UE. The first PC5-S message may include a User Info ID of a second end UE, a User Info ID of the first relay UE, and/or a ProSe Identifier (ID).

In one embodiment, the second PC5-S message may include the User Info of the second end UE, a User Info ID of the second relay UE, the ProSe ID, and/or the RSC. The first PC5-S message or the second PC5-S message may be a Direct Communication Request message or a UE-to-UE Relay Discovery Solicitation message.

Referring back to FIGS. 3 and 4, in one exemplary embodiment from the perspective of a second relay UE. In one embodiment, the second relay UE is provided with a maximum number of hops specific for a RSC by a network. The second relay UE 300 includes a program code 312 stored in the memory 310. The CPU 308 could execute program code 312 to enable the second relay UE (i) to store the maximum number of hops specific for the RSC, (ii) to receive a first PC5-S message from a first relay UE, wherein the first PC5-S message includes a User Info ID of a first end UE, the RSC, and an accumulated number of hops, and (iii) to transmit or broadcast a second PC5-S message, wherein the second PC5-S message includes the User Info ID of the first end UE and a first relay indication to indicate it is allowed to broadcast at least the user info ID of the first end UE if the accumulated number of hops plus 1 is less than the maximum number of hops. Furthermore, the CPU 308 can execute the program code 312 to perform all of the above-described actions and steps or others described herein.

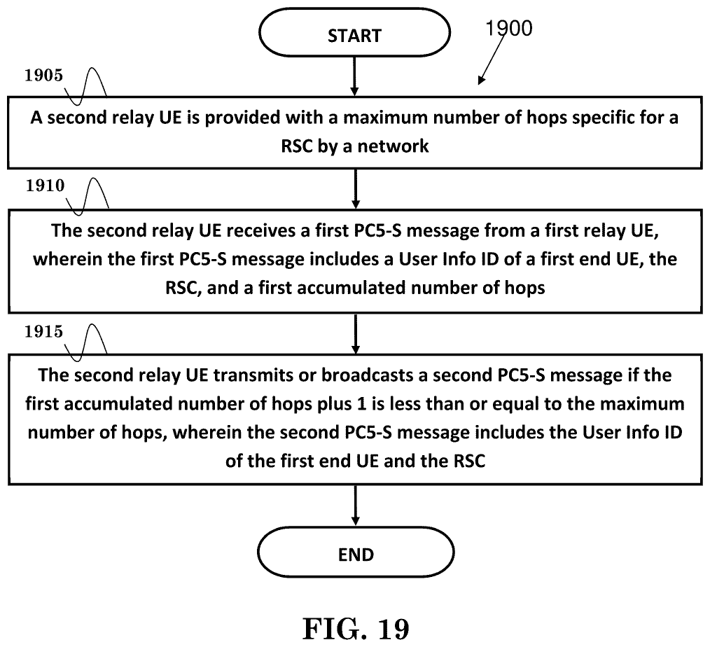

FIG. 19 is a flow chart 1900 of a method for supporting multi-hop UE-to-UE relay. In 1905, a second relay UE is provided with a maximum number of hops specific for a Relay Service Code (RSC) by a network. In 1910, the second relay UE receives a first PC5-S message from a first relay UE, wherein the first PC5-S message includes a User Info ID of a first end UE, the RSC, and a first accumulated number of hops. In 1915, the second relay UE transmits or broadcasts a second PC5-S message if the first accumulated number of hops plus 1 is less than or equal to the maximum number of hops, wherein the second PC5-S message includes the User Info ID of the first end UE and the RSC.

In one embodiment, the second PC5-S message may include a second accumulated number of hops set to the first accumulated number of hops plus 1. The second relay UE may not transmit or broadcast the second PC5-S message if the first accumulated number of hops plus 1 is greater than the maximum number of hops.

In one embodiment, the first PC5-S message may include a User Info ID of a second end UE, a User Info ID of the first relay UE, and/or a ProSe Identifier (ID). The first end UE may communicate with the second end UE via at least the first relay UE and the second relay UE after a connection between the first end UE and the second end UE is established. In other words, communication between the first end UE and the second end UE is done via at least the first relay UE and the second relay UE after the connection between the first end UE and the second end UE is established.

In one embodiment, the second PC5-S message may include the User Info ID of the second end UE, a User Info ID of the second relay UE, and/or the ProSe ID. The method of claim first PC5-S message or the second PC5-S message may be a Direct Communication Request message or a UE-to-UE Relay Discovery Solicitation message.

Referring back to FIGS. 3 and 4, in one exemplary embodiment from the perspective of a second relay UE. In one embodiment, the second relay UE is provided with a maximum number of hops specific for a RSC by a network. The second relay UE 300 includes a program code 312 stored in the memory 310. The CPU 308 could execute program code 312 to enable the second relay UE (i) to store the maximum number of hops specific for the RSC, (ii) to receive a first PC5-S message from a first relay UE, wherein the first PC5-S message includes a User Info ID of a first end UE, the RSC, and a first accumulated number of hops, and (iii) to transmit or broadcast a second PC5-S message if the first accumulated number of hops plus 1 is less than or equal to the maximum number of hops, wherein the second PC5-S message includes the User Info ID of the first end UE and the RSC. Furthermore, the CPU 308 can execute the program code 312 to perform all of the above-described actions and steps or others described herein.

Various aspects of the disclosure have been described above. It should be apparent that the teachings herein could be embodied in a wide variety of forms and that any specific structure, function, or both being disclosed herein is merely representative. Based on the teachings herein one skilled in the art should appreciate that an aspect disclosed herein could be implemented independently of any other aspects and that two or more of these aspects could be combined in various ways. For example, an apparatus could be implemented or a method could be practiced using any number of the aspects set forth herein. In addition, such an apparatus could be implemented or such a method could be practiced using other structure, functionality, or structure and functionality in addition to or other than one or more of the aspects set forth herein.

As an example of some of the above concepts, in some aspects concurrent channels could be established based on pulse repetition frequencies. In some aspects concurrent channels could be established based on pulse position or offsets. In some aspects concurrent channels could be established based on time hopping sequences. In some aspects concurrent channels could be established based on pulse repetition frequencies, pulse positions or offsets, and time hopping sequences.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, processors, means, circuits, and algorithm steps described in connection with the aspects disclosed herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module”), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

In addition, the various illustrative logical blocks, modules, and circuits described in connection with the aspects disclosed herein may be implemented within or performed by an integrated circuit (“IC”), an access terminal, or an access point. The IC may comprise a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

It is understood that any specific order or hierarchy of steps in any disclosed process is an example of a sample approach. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

The steps of a method or algorithm described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such the processor can read information (e.g., code) from and write information to the storage medium. A sample storage medium may be integral to the processor. The processor and the storage medium may reside in an ASIC. The ASIC may reside in user equipment. In the alternative, the processor and the storage medium may reside as discrete components in user equipment. Moreover, in some aspects any suitable computer-program product may comprise a computer-readable medium comprising codes relating to one or more of the aspects of the disclosure. In some aspects a computer program product may comprise packaging materials.

While the invention has been described in connection with various aspects, it will be understood that the invention is capable of further modifications. This application is intended to cover any variations, uses or adaptation of the invention following, in general, the principles of the invention, and including such departures from the present disclosure as come within the known and customary practice within the art to which the invention pertains.

1. A method for supporting multi-hop UE-to-UE relay, comprising:
a second relay UE is provided with a maximum number of hops specific for a Relay Service Code (RSC) by a network;
the second relay UE receives a first PC5-S message from a first relay UE, wherein the first PC5-S message includes a User Info Identity (ID) of a first end UE, the RSC, and a first accumulated number of hops; and
the second relay UE transmits or broadcasts a second PC5-S message if the first accumulated number of hops plus 1 is less than or equal to the maximum number of hops, wherein the second PC5-S message includes the User Info ID of the first end UE and the RSC.

2. The method of claim 1, wherein the second PC5-S message includes a second accumulated number of hops set to the first accumulated number of hops plus 1.

3. The method of claim 1, wherein the second relay UE does not transmit or broadcast the second PC5-S message if the first accumulated number of hops plus 1 is greater than the maximum number of hops.

4. The method of claim 1, wherein the first PC5-S message includes a User Info ID of a second end UE, a User Info ID of the first relay UE, and/or a ProSe Identifier (ID).

5. The method of claim 4, wherein communication between the first end UE and the second end UE is done via at least the first relay UE and the second relay UE after a connection between the first end UE and the second end UE is established.

6. The method of claim 1, wherein the second PC5-S message includes the User Info ID of the second end UE, a User Info ID of the second relay UE, and/or the ProSe ID.

7. The method of claim 1, wherein the first PC5-S message or the second PC5-S message is a Direct Communication Request message or a UE-to-UE Relay Discovery Solicitation message.

8. A method for supporting multi-hop UE-to-UE relay, comprising:
a second relay UE is provided with a maximum number of hops specific for a Relay Service Code (RSC) by a network;
the second relay UE receives a first PC5-S message from a first relay UE, wherein the first PC5-S message includes a User Info Identity (ID) of a first end UE, the RSC, and an accumulated number of hops; and
the second relay UE transmits or broadcasts a second PC5-S message, wherein the second PC5-S message includes the User Info ID of the first end UE and a first relay indication to indicate it is allowed to broadcast at least the user info ID of the first end UE if the accumulated number of hops plus 1 is less than the maximum number of hops.

9. The method of claim 8, wherein the second PC5-S message includes a second relay indication to indicate it is not allowed to broadcast at least the User Info ID of the first end UE if the accumulated number of hops plus 1 is equal to the maximum number of hops.

10. The method of claim 8, wherein the second PC5-S message does not include the first relay indication if the accumulated number of hops plus 1 is equal to the maximum number of hops.

11. The method of claim 8, wherein the first PC5-S message includes another relay indication to indicate it is allowed to broadcast at least the User Info ID of the first end UE.

12. The method of claim 8, wherein the first PC5-S message includes a User Info ID of a second end UE, a User Info ID of the first relay UE, and/or a ProSe Identifier (ID).

13. The method of claim 8, wherein the second PC5-S message includes the User Info ID of the second end UE, a User Info ID of the second relay UE, the ProSe ID, and/or the RSC.

14. The method of claim 8, wherein the first PC5-S message or the second PC5-S message is a Direct Communication Request message or a UE-to-UE Relay Discovery Solicitation message.

15. A second relay User Equipment (UE), comprising:
a control circuit;
a processor installed in the control circuit; and
a memory installed in the control circuit and operatively coupled to the processor;
wherein the processor is configured to execute a program code stored in the memory to:
store a maximum number of hops specific for a Relay Service Code (RSC) provided by a network;
receive a first PC5-S message from a first relay UE, wherein the first PC5-S message includes a User Info Identity (ID) of a first end UE, the RSC, and a first accumulated number of hops; and
transmit or broadcast a second PC5-S message if the first accumulated number of hops plus 1 is less than or equal to the maximum number of hops, wherein the second PC5-S message includes the User Info ID of the first end UE and the RSC.

16. The second relay UE of claim 15, wherein the second PC5-S message includes a second accumulated number of hops set to the first accumulated number of hops plus 1.

17. The second relay UE of claim 15, wherein the second relay UE does not transmit or broadcast the second PC5-S message if the first accumulated number of hops plus 1 is greater than the maximum number of hops.

18. The second relay UE of claim 15, wherein the first PC5-S message includes a User Info ID of a second end UE, a User Info ID of the first relay UE, and/or a ProSe Identifier (ID).

19. The second relay UE of claim 15, wherein the second PC5-S message includes the User Info ID of the second end UE, a User Info ID of the second relay UE, and/or the ProSe ID.

20. The second relay UE of claim 15, wherein the first PC5-S message or the second PC5-S message is a Direct Communication Request message or a UE-to-UE Relay Discovery Solicitation message.
